(19) United States
(12) Patent Application Publication
(10) Pub. No.: US 2018/0188844 A1
(43) Pub. Date: Jul. 5, 2018

(54) MULTIPHASE SIGNALING FOR SCAN TIME REDUCTION FOR A TOUCH SYSTEM

(71) Applicant: TEXAS INSTRUMENTS INCORPORATED, DALLAS, TX (US)

(72) Inventors: ASHISH KHANDELWAL, IRVING, TX (US); SRINATH HOSUR, PLANO, TX (US); BERK GUVELIOGLU, RICHARDSON, TX (US)

(21) Appl. No.: 15/395,420

(22) Filed: Dec. 30, 2016

(51) Int. Cl. G06F 3/044

(52) U.S. Cl. CPC G06F 3/044

(57) ABSTRACT

A system includes a transmitter to transmit excitation signals. At least one of the excitation signals is transmitted to at least one row or column of a touch system and at least one other of the signals is concurrently transmitted to at least one other row or column of the touch system. The transmitter generates at least one of the excitation signals at a given phase to one row or column of the touch system and generates the other of the excitation signals at a different phase from the given phase to the other row or column of the touch system.

### TECHNICAL FIELD

This relates generally to integrated circuits, and more particularly to a system and method to reduce the scan time of a touch system via multiphase signaling and processing to/from the system.

### BACKGROUND

A touch system includes interfaces such as touch screens that can include an input device and output device layered on top of an electronic visual display of an information processing system. For example, a user can provide input or control the information processing system through simple or multi-touch gestures by touching the screen with a special stylus and/or one or more fingers. Touch screens are common in devices, such as game consoles, personal computers, tablet computers, electronic voting machines, and smart phones. These interfaces can also be attached to computers or, as terminals, to networks.

To detect user gestures such as touching via the touch system interface, common technologies include resistive touch screens and capacitive touch screens can be employed. An example capacitive touch screen panel consists of an insulator such as glass, coated with a transparent conductor such as indium tin oxide. As the human body is also an electrical conductor, touching the surface of the screen results in a distortion of the screen's electrostatic field, measurable as a change in capacitance. Different technologies may be used to determine the location of the touch. In some touch systems, mutual or self capacitance can be measured by transmitting a signal on a row/column of the touch screen interface and receiving the signal on a respective column/row. When the touch occurs close to a row/column intersection, the received change in signal strength and/or signal phase changes. This change isolates the touch location.

### SUMMARY

In described examples, a system includes a transmitter to transmit excitation signals. At least one of the excitation signals is transmitted to at least one row or column of a touch system and at least one other of the excitation signals is concurrently transmitted to at least one other row or column of the touch system. The transmitter generates at least one of the excitation signals at a given phase to one row or column of the touch system and generates the other of the excitation signals at a different phase from the given phase to the other row or column of the touch system.

In another example, a system includes a receiver to receive an output signal from a touch system. The receiver includes at least two receiving circuits to process the output signal from the touch system. The output signal is received in response to at least two excitation signals applied to at least two rows or columns of the touch system. At least one of the excitation signals is received at a given phase from at least one row or column of the touch system. At least one other of the excitation signals is received at a given phase from at least one other row or column of the touch system.

In yet another example, a method includes transmitting excitation signals that are out of phase with respect to each other to a touch system. At least one of the excitation signals is transmitted to at least one row or column of the touch system, and at least one other of the excitation signals is concurrently transmitted to at least one other row or column of the touch system. The method includes receiving an output signal from the touch system in response to the excitation signals. The output signal includes a combined response from two or more rows or columns of the touch system excited by the excitation signals. The method includes summing the output signal with each of the excitation signals to generate an extrapolated signal to determine the row or column excited in response to the excitation signals.

### BRIEF DESCRIPTION OF THE DRAWINGS

FIG. 1 is a schematic block diagram of an example system to reduce the scan time of a touch system via multiphase signaling and processing.

FIG. 2 is a circuit diagram of a receiver and transmitter for an example touch system that uses multiphase signaling and processing.

FIG. 3 is a circuit diagram of an example touch system that can be excited and analyzed via multiphase signaling.

FIG. 4 is a circuit diagram of an example transmitter and receiver circuit that uses multiphase signaling and processing.

FIG. 5 is a flow diagram of an example method to reduce the scan time of a touch system via multiphase signaling and processing.

### DETAILED DESCRIPTION

In example embodiments, a transmitter transmits excitation signals that are out of phase with respect to each other (e.g., a sin wave generated as one excitation signal and a cos wave generated as another excitation signal). At least one of the of excitation signals is transmitted to at least one row or column of a touch system and at least one other of the excitation signals is concurrently transmitted to at least one other row or column of the touch system. An output signal having a combination of signals from each of the excitation signals is received by a receiver in response to the excitation signals transmitted to the touch system. Receiver circuits extrapolate the row or column information from the output signal based on the phase of the excitation signals. For example, in a two phase excitation system, at least two receiver circuits include a summing junction to extrapolate signal phases from the output signal to determine which of at least two rows or columns was touched.

At one of the summing junctions of the receiver circuit, the output signal is summed with the excitation signal at a given phase to extrapolate the row or column excited in response to the given phase. At the other of the summing junctions of the at receiver circuits, the output signal is summed with the excitation signal at a different phase to extrapolate the row or column excited in response to the different phase. By concurrently analyzing two or more rows or columns of a touch system, the amount of time to scan the touch system via the excitation signals can be reduced. For example, in a two excitation signal system, the amount of time to scan the touch system can be reduced by half, because two rows/columns are analyzed concurrently (instead of individually in conventional systems). Also, if the scan time is kept the same, reduced, the hardware complexity and cost of the touch system can be reduced because a smaller amount of the same number of row/column signals from the touch system can be processed by re-using a smaller amount of hardware used. Thus, an increased or similar amount of touch information can be obtained from the touch system in less time and/or via less hardware by utilizing concurrent signaling and processing described herein.

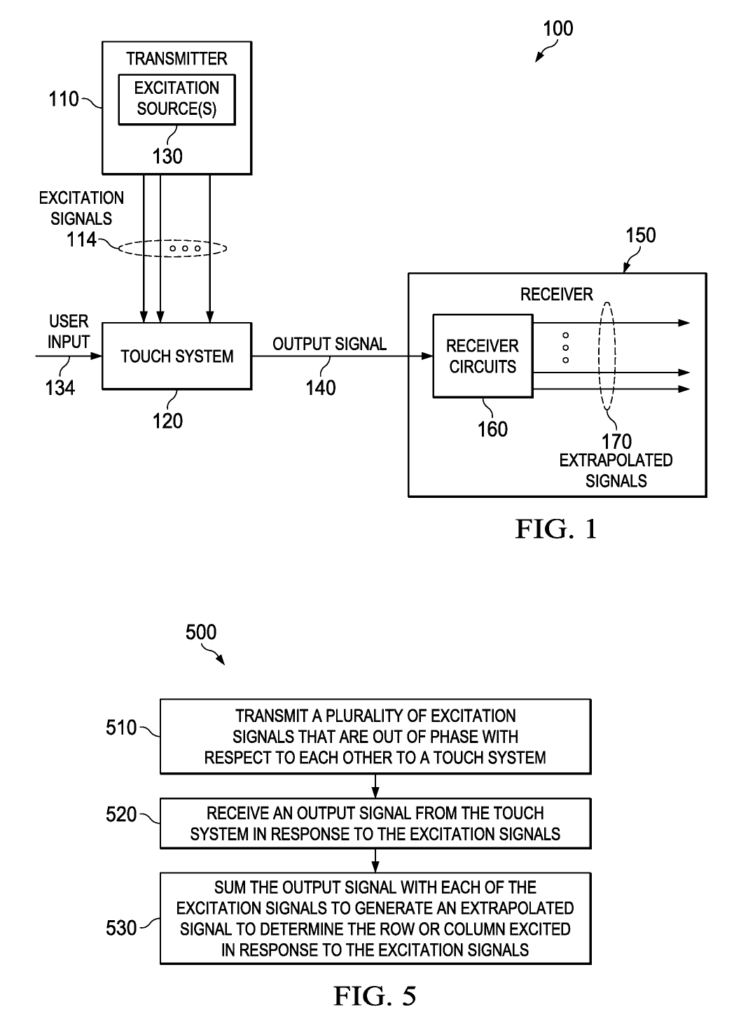

FIG. 1 illustrates an example system 100 to reduce the scan time of a touch system via multiphase signaling and processing. The system 100 includes a transmitter 110 to transmit excitation signals 114. At least one of the excitation signals 114 can be transmitted to at least one row or column of a touch system 120 and at least one other of the excitation signals can be concurrently transmitted to at least one other row or column of the touch system. The transmitter 110 generates at least one of the excitation signals 114 at a given phase to one row or column of the touch system 120 and generates the other of the excitation signals at a different phase from the given phase to the other row or column of the touch system. For example, one excitation signal 114 may be generated as a sin wave and another excitation signal generated as a cos wave. As described hereinbelow, other phase relationships are possible.

The transmitter 110 includes at least one alternating current (AC) source 130 to generate the excitation signals 114 to the touch system 120 where each of the excitation signals are transmitted out of phase with respect to each other excitation signal. At least two of the excitation signals 114 can be generated at the same frequency or at different frequencies with respect to each other via the AC source 130. Different frequencies can be employed for the excitation signals 114 so long as they remain in their given phase relationship (e.g., orthogonal) over the integration time which includes both the time it takes to transmit and receive signals in response to the excitation signals 114.

In one example, at least two of the excitation signals 114 can be transmitted to at least two rows or columns of the touch system 120 where the excitation signals are at least 90 degrees out of phase with respect to each other when transmitted to the respective rows or columns. In other examples, more than two excitation signals 114 can be transmitted to the touch system to further reduce scan time of the touch system. As used herein, the term “scan time” refers to the amount of time it takes to excite each respective row or column of the touch system 120. In conventional single phase excitation systems, each row or column had to be excited individually to detect the presence of a touch shown as user input 134. In the multiphase system described herein, multiple rows or columns can be analyzed concurrently to reduce the scan time in half in a two phase excitation system (or reduced more if more than two excitation signals utilized).

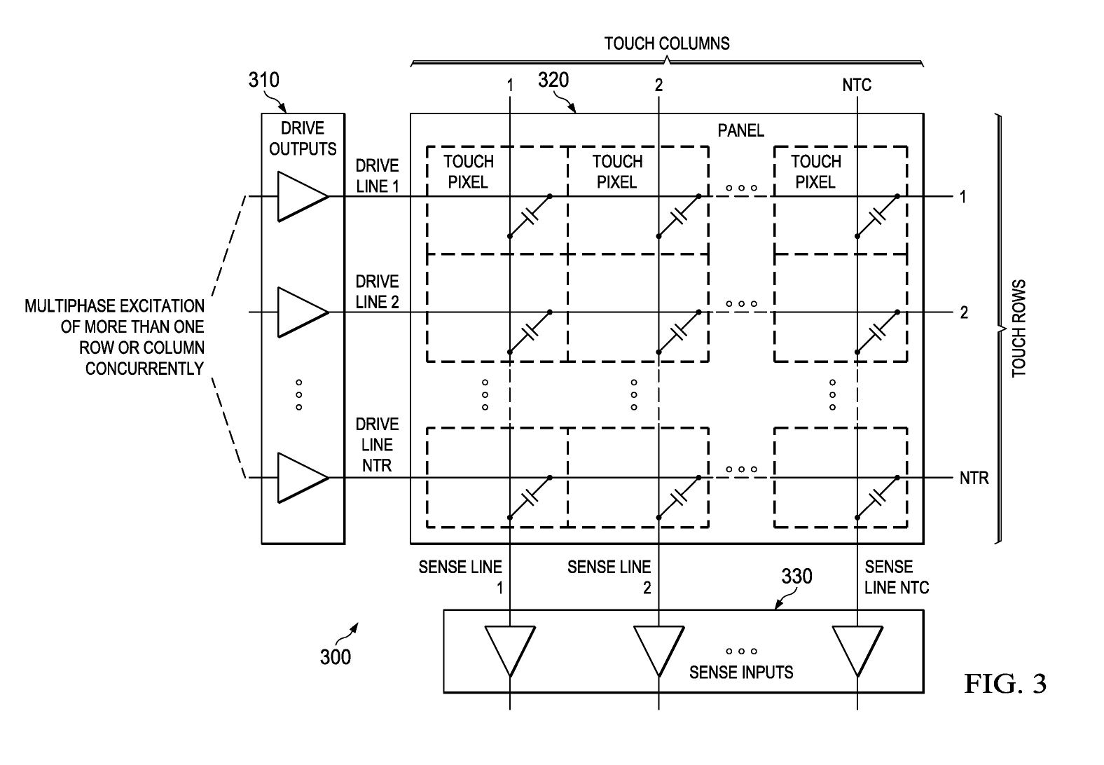

The touch system 120 can be a mutual capacitance touch system (see e.g., FIG. 3) having at least two rows and columns that receive the excitation signals 114 from the transmitter 110 where the touch system generates an output signal 140 based on the excitation signals. A receiver 150 receives the output signal 140 from the touch system 120. The receiver 150 includes at least two receiver circuits 160 to process the output signal 140 from the touch system 120 and to determine if or where a user has touched the touch system. As used herein, the term “circuit” can include a collection of active and/or passive elements that perform a circuit function, such as an analog circuit or control circuit. Additionally or alternatively, for example, the term “circuit” can include an integrated circuit (IC) where all and/or some of the circuit elements are fabricated on a common substrate (e.g., semiconductor substrate).

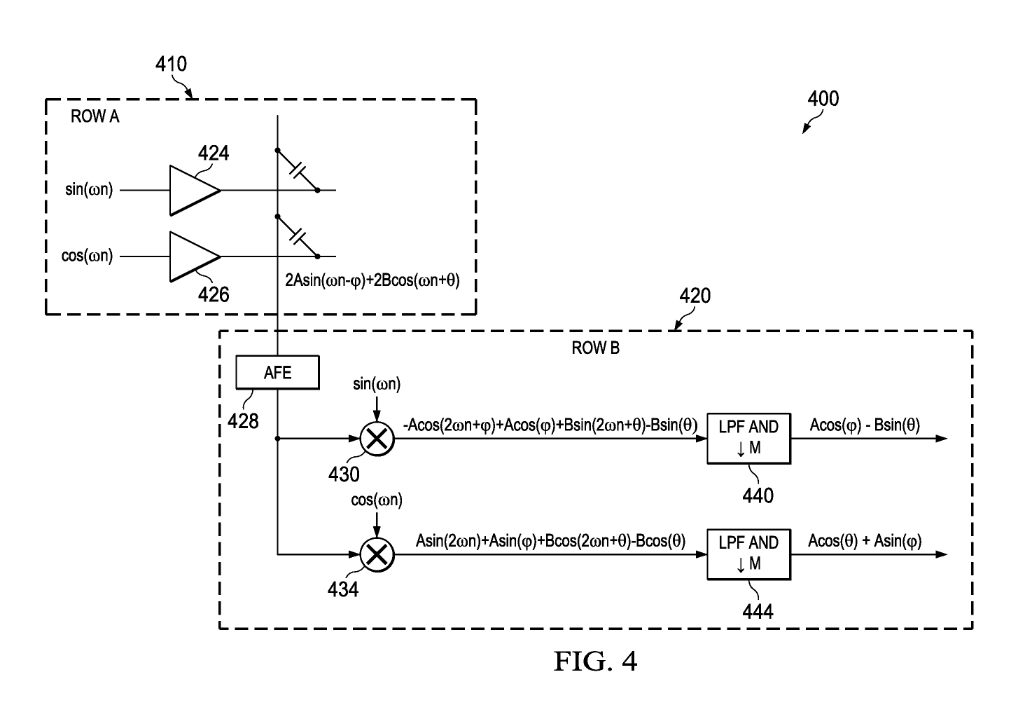

Each of the receiver circuits 160 can include a summing junction (see e.g., FIG. 4) to extrapolate signal phases 170 from the output signal 140 to determine which of the rows or columns was touched from the touch system 120. At one of the summing junctions of the receiver circuits 160, the output signal 140 is summed with the excitation signal at the given phase to extrapolate the row or column excited in response to the given phase. At the other of the summing junctions of the receiver circuits 160, the output signal 140 is summed with the excitation signal at the different phase to extrapolate the row or column excited in response to the different phase. The output of each of the summing junctions can be filtered via a low pass filter to facilitate extrapolating the row or column that was touched from the output of each of the summing junctions in the receiver circuit 160.

By providing multiphase signaling and analysis as described herein to reduce scan time of the touch system, a portion of the touch system 120 can be excited by the transmitter 110 during one scanning sequence and analyzed by the receiver 150 based on the scanning of the portion. At least one other portion of the touch system 120 can be excited by the transmitter 110 during another scanning sequence and analyzed by the receiver based on the scanning of the at least one other portion. In this manner of multiphase signaling and processing, hardware complexity can be reduced because multiple rows or columns can be scanned using fewer connection nodes to the touch system 120 to determine a touch to the system (e.g., in a two phase excitation system, half of the row or column connections from conventional systems can be reduced).

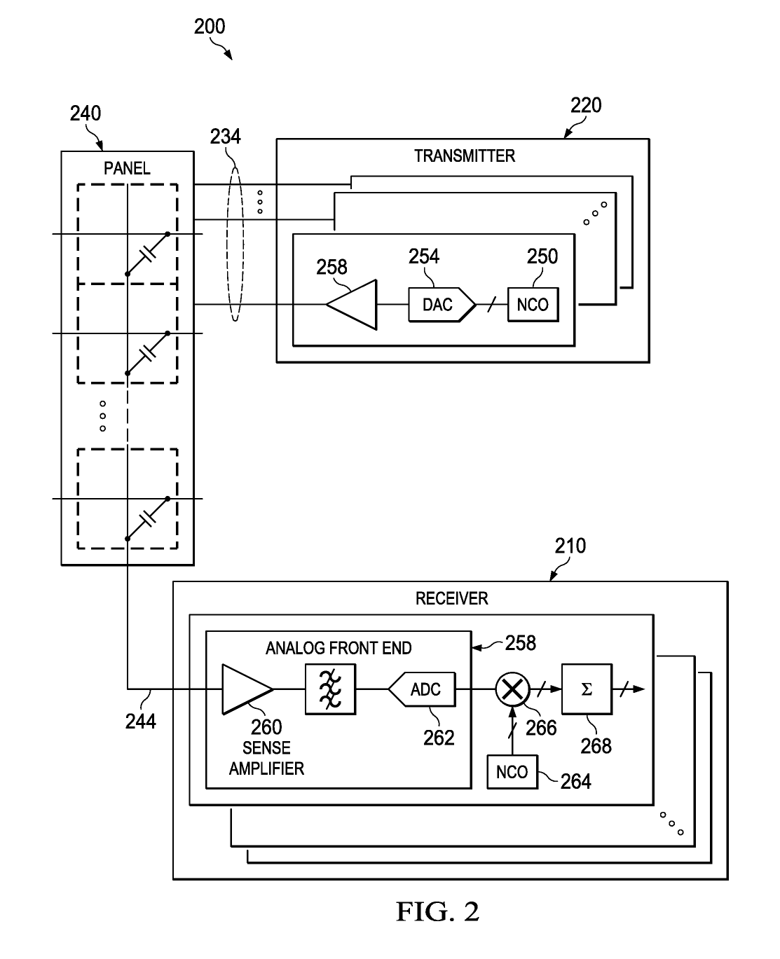

FIG. 2 illustrates an example circuit 200 of a receiver 210 and a transmitter 220 for a touch system where multiphase excitation and processing is employed. The transmitter 220 provides multiple out of phase excitation signals 234 to a touch panel 240. The transmitter 220 can provide row or column excitation to the touch panel 240 to detect a user's touch where more than one row or column are excited concurrently via the excitation signals 234. In this example, a capacitance touch panel 240 is illustrated. In a touch system, mutual or self capacitance can be measured by transmitting the excitation signals 234 to selected rows/columns of the panel 240. The receiver 210 receives a signal 244 in response to the excitation signals 234 applied on the columns/rows of the touch panel 240. When a touch occurs close to a row/column intersection, the received change in signal strength and/or phase change can be detected by the receiver 210. This change isolates the touch location on the touch panel 240.

The transmitter 220 can include at least one numerically controlled oscillator (NCO) 250 which drives a digital to analog converter (DAC) 254, which in turn drives an output amplifier 258 to provide the signals 234. The receiver 210 can include an analog front end 258 that includes an input stage or amplifier 260 which drives an analog to digital converter (ADC) 262. Output from the ADC can be multiplied via and NCO 264 at 266 which is then summed at 268. As described hereinbelow with reference to FIG. 4, the receiver 210 can include summing junctions and filters (e.g., before or after the sense amplifier 260) to extrapolate row/column information from the signal 244 as described herein.

FIG. 3 illustrates an example of a touch system 300 that can be excited and analyzed via multiphase signaling. In the touch system 300, a known signal is transmitted via sources which is coupled through a touch panel 320 and then received by the receiver via sense inputs 330. The change in the gain/phase of the received signal from one or more of the sense inputs 330 indicates the presence or absence of a touch. In conventional touch systems, each transmitter (row/drive line) is stimulated, usually with a sinusoidal signal at a known frequency for a certain period of time. The received signal is simultaneously measured by a number of receive channels via inputs 330. The change in capacitance on any receive channel indicates the presence of a touch close to the intersection of the transmit channel (row) and that receive channel (column). In conventional systems, the transmit channels are then scanned row by row to obtain the touch image.

To reduce the area of the touch controller circuit in conventional single excitation systems, one can reduce the number of receive and/or transmit channels. However this increases the scan time. The scan time increases by the same factor as the hardware reduction. For example, if the hardware is reduced by a factor of 2, the scan time increases by a factor 2 to obtain the same performance level. However, an increase in scan time decreases the responsiveness of the touch screen controller. In the system and methods described herein, multiphase signaling is provided where two or more rows/columns of the touch panel 320 are excited concurrently effectively reducing the scan time. When the scan time is reduced, hardware complexity can thereby also be reduced.

FIG. 4 illustrates a circuit diagram of an example transmitter 410 and receiver circuit 420 that uses multiphase signaling and processing. In this example, a SIN signal sin(ωn) is transmitted on row 1 via source 424 and a COS signal cos(ωn) on row 2 transmitted concurrently via source 426. Both the SIN and COS can be at the same or different frequencies. When choosing different frequencies, the multiphase signals should remain orthogonal (e.g., in substantially the same phase relationship) over the integration time (transmit and receive time).

At the receiver circuit 420, the received signal represented as 2A sin(ωn+φ)+2B cos(ωn+θ) in this example, can be received via analog front end (AFE) 428 and can be match filtered with the transmitted SIN and COS signal in the digital domain via summing junctions 430 and 434, respectively. For example, output from the summing junction 430 can be represented as −A cos(2ωn+φ)+A cos(φ)+B sin(2ωn+θ)−B sin(θ), and output from the other summing junction can be represented as A sin(2ωn)+A sin(φ)+B cos(2ωn+θ)+B cos(θ). These signals can be filtered via low pas filters 440 and 444, respectively to produce output signals A cos(φ)−B sin(θ) and B cos(θ)+A sin(φ), respectively.

Because the signals can be maintained in a given phase relationship with respect to each other (e.g., orthogonal), changes in the signal strength of the SIN indicates a touch on row 1 and the corresponding receiver while any change in COS will give the touch information on row 2 and the receiver of interest. Thus, information about two touch electrodes can be obtained concurrently. This implies that scanning in pairs, the touch image can be obtained in half the time. As described hereinabove, more than two rows can be concurrently scanned and analyzed. One half the number of receivers can be employed in an example to facilitate scanning the panel twice (e.g., getting half the entire panel information from the first scan and one half from the second scan). Thus, the total scan time using multiphase stimulation remains substantially the same while the hardware complexity is reduced. In some example, the receive channel can be built with a higher dynamic range to account for interference. Therefore, sending multiphase signals does not impact the individual receiver design. Thus, a factor of two hardware improvement can be easily obtained using two excitation signals. This can also be easily extended to larger number of concurrent excitations.

In view of the structural and functional features described hereinabove, an example method is described with reference to FIG. 5. For clarity, the method is shown and described as executing serially, but parts of the method could occur in different orders and/or concurrently from that shown and described herein. Such method can be executed by various components, such as components configured in an integrated circuit, a processor or a controller.

FIG. 5 illustrates an example method 500 to reduce the scan time of a touch system via multiphase signaling and processing. At 510, the method 500 includes transmitting excitation signals that are out of phase with respect to each other to a touch system (e.g., via transmitter 110 of FIG. 1). At least one of the excitation signals is transmitted to at least one row or column of the touch system and at least one other of the signals is concurrently transmitted to at least one other row or column of the touch system. At 520, the method 500 includes receiving an output signal from the touch system in response to the excitation signals (e.g., via receiver 150 of FIG. 1). The output signal includes a combined response from two or more rows or columns of the touch system excited by the excitation signals. At 530, the method 500 includes summing the output signal with each of the excitation signals to generate an extrapolated signal to determine the row or column excited in response to the excitation signals (e.g., via receiver circuits 160 of FIG. 1). The method 500 can also include filtering the extrapolated signal to determine the row or column excited in response to the excitation signals.

Modifications are possible in the described embodiments, and other embodiments are possible, within the scope of the claims.

What is claimed is:

1. A system, comprising:
a transmitter to transmit excitation signals, at least one of the excitation signals transmitted to at least one row or column of a touch system and at least one other of the excitation signals concurrently transmitted to at least one other row or column of the touch system, the transmitter generates at least one of the excitation signals at a given phase to the at least one row or column of the touch system and generates the at least one other of the excitation signals at a different phase from the given phase to the at least one other row or column of the touch system.

2. The system of claim 1, wherein the transmitter includes at least one alternating current (AC) source to generate the excitation signals to the touch system, each of the excitation signals are transmitted out of phase with respect to each other excitation signal.

3. The system of claim 2, wherein at least two of the excitation signals are generated at the same frequency or at different frequencies with respect to each other via the AC source.

4. The system of claim 2, wherein at least two of the excitation signals are transmitted to at least two rows or columns of the touch system, the excitation signals are at least 90 degrees out of phase with respect to each other when transmitted to the respective rows or columns.

5. The system of claim 1, further comprising a mutual capacitance touch system having at least two rows and columns that receive the excitation signals from the transmitter, wherein the touch system generates an output signal based on the excitation signals.

6. The system of claim 5, further comprising a receiver to receive the output signal from the touch system, the receiver includes at least two receiver circuits to process the output signal from the touch system.

7. The system of claim 6, wherein each of the at least two receiver circuits include a summing junction to extrapolate signal phases from the output signal to determine which of the at least two rows or columns was touched, wherein at one of the summing junctions of the at least two receiver circuits the output signal is summed with the excitation signal at the given phase to extrapolate the row or column excited in response to the given phase, and at the other of the summing junctions of the at least two receiver circuits the output signal is summed with the excitation signal at the different phase to extrapolate the row or column excited in response to the different phase.

8. The system of claim 7, wherein the output of each of the summing junctions is filtered via a low pass filter to facilitate extrapolating the row or column that was touched from the output of each of the summing junctions.

9. The system of claim 7, wherein a portion of the touch system is excited by the transmitter during one scanning sequence and analyzed by the receiver based on the scanning of the portion, and at least one other portion of the touch system is excited by the transmitter during another scanning sequence and analyzed by the receiver based on the scanning of the at least one other portion.

10. A system, comprising:
a receiver to receive an output signal from a touch system, the receiver includes at least two receiver circuits to process the output signal from the touch system, the output signal received in response to at least two excitation signals applied to at least two rows or columns of the touch system, at least one of the excitation signals is received at a given phase from at least one row or column of the touch system and at least one other of the excitation signals is received at a given phase from at least one other row or column of the touch system.

11. The system of claim 10, further comprising a transmitter to generate the at least two excitation signals, wherein the transmitter includes at least one alternating current (AC) source to generate the excitation signals to the touch system, each of the excitation signals are transmitted out of phase with respect to each other.

12. The system of claim 11, wherein the at least two excitation signals are generated at the same frequency or at different frequencies with respect to each other via the AC source.

13. The system of claim 11, wherein the at least two excitation signals are transmitted to at least two rows or columns of the touch system, the excitation signals are at least 90 degrees out of phase with respect to each other when transmitted to the respective rows or columns.

14. The system of claim 10, further comprising a mutual capacitance touch system having at least two rows and columns that receive the excitation signals, wherein the touch system generates an output signal in response to the excitation signals.

15. The system of claim 14, wherein each of the at least two receiver circuits include a summing junction to extrapolate signal phases from the output signal to determine which of the at least two rows or columns was touched, wherein at one of the summing junctions of the at least two receiver circuits the output signal is summed with the excitation signal at the given phase to extrapolate the row or column excited in response to the given phase, and at the other of the summing junctions of the at least two receiver circuits the output signal is summed with the excitation signal at the different phase to extrapolate the row or column excited in response to the different phase.

16. The system of claim 15, wherein the output of each of the summing junctions is filtered via a low pass filter to facilitate extrapolating the row or column that was touched from the output of each of the summing junctions.

17. The system of claim 16, wherein a portion of the touch system is excited during one scanning sequence and analyzed by the receiver based on the scanning of the portion, and at least one other portion of the touch system is excited during another scanning sequence and analyzed by the receiver based on the scanning of the at least one other portion.

18. A method, comprising:
transmitting excitation signals that are out of phase with respect to each other to a touch system, at least one of the excitation signals transmitted to at least one row or column of the touch system and at least one other of the excitation signals concurrently transmitted to at least one other row or column of the touch system;
receiving an output signal from the touch system in response to the excitation signals, wherein the output signal includes a combined response from two or more rows or columns of the touch system excited by the excitation signals; and
summing the output signal with each of the excitation signals to generate an extrapolated signal to determine the row or column excited in response to the excitations signals.

19. The method of claim 18, filtering the extrapolated signal to determine the row or column excited in response to the excitation signals.

20. The method of claim 19, further comprising transmitting the excitation signals to at least two rows or columns of the touch system, the excitation signals are about 90 degrees out of phase with respect to each other when transmitted to the respective rows or columns.
